(19) United States
(12) Patent Application Publication
(10) Pub. No.: US 2006/0230678 A1
(43) Pub. Date: Oct. 19, 2006

(54) Planter for hydrating a plant

(76) Inventor: Emmanuel Ellis-El, Grand Rapids, MI (US)

Correspondence Address: ROBERT J. SAYFIE, P.C., 161 OTTAWA AVENUE NW, SUITE 407, GRAND RAPIDS, MI, 49503, US

(21) Appl. No.: 11/107,168

(22) Filed: Apr. 15, 2005

(51) Int. Cl. A01G 27/00

(52) U.S. Cl. 47/79

(57) ABSTRACT

A planter having a wall configuration whereby a plurality of walls and surfaces define a reservoir for water, and a reservoir intake opening that can be sealed by a cap; an outer wall having an outer top ridge that is secured to a top surface, said outer wall disposed radially away from an inner wall, said outer wall extending downwardly from said top ridge to an outer bottom surface, said outer wall and said outer bottom surface disposed substantially concentric with said inner wall said inner bottom surface; said top surface, said outer wall, said outer bottom wall, said inner wall, and said inner bottom wall collectively define a reservoir; and said inner wall, said inner bottom wall enclose an plant area; whereby a ratio of said plant area to said reservoir is specified.

### BACKGROUND

1. Field of the Invention

This invention relates to containers for plants. This invention holds water for a lengthy period of time and the plant(s) can “drink” the water from the soil which is moistened through an aperture disposed between the soil and a water reservoir contained in the planter.

2. Description of Related Art

There exist many types of plant holders in the public domain. There also exist planters called self watering planters (U.S. Pat. Nos. 3,903,644, 4,001,967). Some of these require vacuum construction to work properly. This applicant's does not. Many of the prior patents rely on vacuum pressure to water the plants. This invention does not require vacuums. U.S. Pat. No. 4,286,408 uses a means of condensation and solar heat to water the plant(s). None of the other planters utilize the features of gravity, osmosis, and particularly the ratio of the water within the reservoir, the watering aperture, and the soil volume of the applicant's invention.

### OBJECTS AND ADVANTAGES

One aspect of this invention is a self-watering planter, comprising: an inner bottom surface (50) having a soil aperture (80), said soil aperture having a diameter of about ⅛ of an inch; an inner wall (30) extending upwardly from said inner bottom surface (50), said inner wall (30) terminating in an inner ridge (31); a top surface (20) secured to said inner ridge (31), said top surface (20) extending radially outwardly in a substantially horizontal plane to an outer wall (40), said top surface (20) having a reservoir intake opening (75) that can be sealed by a cap (70); said outer wall (40) having an outer top ridge (41) that is secured to said top surface 20, said outer wall disposed radially away from said inner wall (30), said outer wall (40) extending downwardly from said top ridge (41) to an outer bottom surface (55), said outer wall (40) and said outer bottom surface (55) disposed substantially concentric with said inner wall (30) and said inner bottom surface (50); said top surface (20), said outer wall (40), said outer bottom wall (55), said inner wall (30), and said inner bottom wall (50) collectively define a reservoir (90) therebetween; and said inner wall (30), said inner bottom wall (50) enclose an plant area (42); whereby a ratio of said plant area to said reservoir is about 2.895 to 1.

In yet another aspect of this invention, a self-watering planter, wherein the improvement comprises: an inner bottom surface (50) having a soil aperture (80); an inner wall (30) extending upwardly from said inner bottom surface (50), said inner wall (30) terminating in an inner ridge (31); a top surface (20) secured to said inner ridge (31), said top surface (20) extending radially outwardly in a substantially horizontal plane to an outer wall (40), said top surface (20) having a reservoir intake opening (75) that can be sealed by a cap (70); said outer wall (40) having an outer top ridge (41) that is secured to said top surface 20, said outer wall disposed radially away from said inner wall (30), said outer wall (40) extending downwardly from said top ridge (41) to an outer bottom surface (55), said outer wall (40) and said outer bottom surface (55) disposed substantially concentric with said inner wall (30) and said inner bottom surface (50); said top surface (20), said outer wall (40), said outer bottom wall (55), said inner wall (30), and said inner bottom wall (50) collectively define a reservoir (90) therebetween; and said inner wall (30), said inner bottom wall (50) enclose an plant area (42); whereby a ratio of said plant area to said reservoir is about 2.9 to 1.

Another aspect of this invention is a self-watering planter, wherein the improvement comprises: an inner bottom surface (50) having a soil aperture (80); an inner wall (30) extending upwardly from said inner bottom surface (50), said inner wall (30) terminating in an inner ridge (31); a top surface (20) secured to said inner ridge (31), said top surface (20) extending radially outwardly in a substantially horizontal plane to an outer wall (40), said top surface (20) having a reservoir intake opening (75) that can be sealed by a cap (70); said outer wall (40) having an outer top ridge (41) that is secured to said top surface 20, said outer wall disposed radially away from said inner wall (30), said outer wall (40) extending downwardly from said top ridge (41) to an outer bottom surface (55), said outer wall (40) and said outer bottom surface (55) disposed substantially concentric with said inner wall (30) and said inner bottom surface (50); said top surface (20), said outer wall (40), said outer bottom wall (55), said inner wall (30), and said inner bottom wall (50) collectively define a reservoir (90) therebetween; and said inner wall (30), said inner bottom wall (50) enclose an plant area (42); whereby a ratio of said plant area to said reservoir is about 3 to 1.

Accordingly, besides the objects and advantages of the self watering planter, several objects and advantages of the present invention are:

a) to provide a planter which requires less maintenance than does a planter without the self-watering process in my invention;

b) to provide a self-watering planter that provides an amount of liquid to the soil that is not too much, or not too little;

c) to provide a self-watering planter that does not foster parasite growth in the soil.

Numerous innovations for self feeding planters have been provided in the prior art that are adapted to be used. Even though these innovations may be suitable for the specific individual purposes to which they address, they would not be suitable for the purposes of the present invention as heretofore described.

### DESCRIPTION OF DRAWINGS

FIG. 1 is a pictorial view of the planter;

FIG. 2 is a pictorial of a top view of the planter;

FIG. 3 is pictorial of a side sectional view along line 3-3 from FIG. 2;

FIG. 4 is a pictorial of a side view of the planter;

### REFERENCE NUMERALS IN DRAWINGS

| | |
|---|---|
| 10 | Hydrating System |
| 20 | Top Surface |
| 30 | Inner Wall |
| 31 | Inner Ridge |
| 40 | Outer Wall |
| 41 | Outer Ridge |
| 42 | Plant Area |
| 50 | Inner Bottom Surface |
| 55 | Outer Bottom Surface |
| 60 | Lip |
| 70 | Cap |
| 75 | Reservoir Intake Aperture |
| 80 | Soil Aperture |
| 90 | Reservoir |

### DETAILED DESCRIPTION

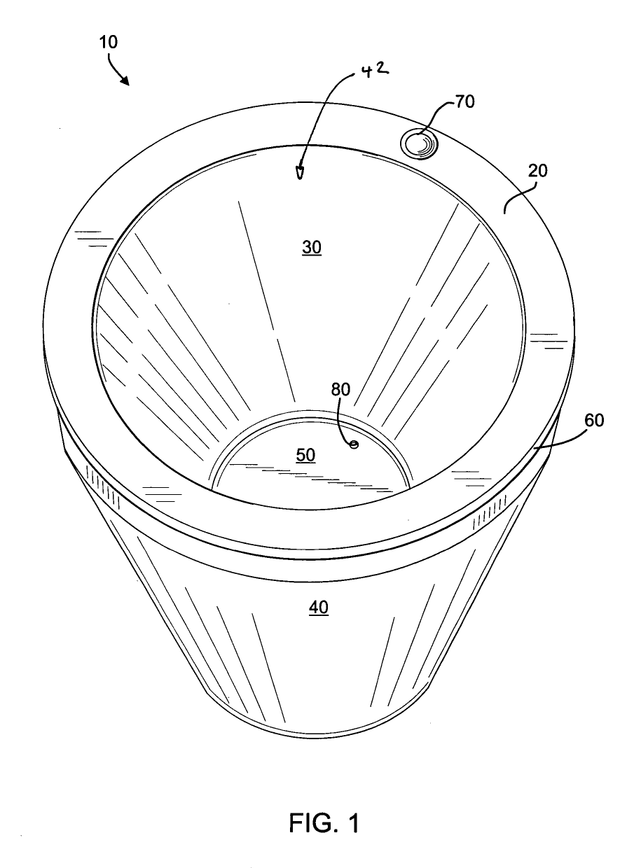

A typical embodiment of the system for hydrating a plant is illustrated in FIG. 1. A housing 10 is comprised of an inner bottom surface 50. Said inner bottom surface 50 has an inner wall 30 extending away therefrom to a top surface 20. The inner bottom surface 50 has a soil aperture 80. Disposed substantially concentric with said inner bottom surface 50 and said inner wall 30, is an outer bottom surface 55 and outer wall 40, respectively. The outer wall 40 also extents to said top surface 20.

As illustrated in FIG. 3, said outer bottom surface 55 and said outer wall 40 are spaced away from said inner bottom surface 50 and said inner wall 30 so as to define a reservoir 90 therein. This can be accomplished by securing the outer wall 40 to the inner wall 30 via the top surface 20.

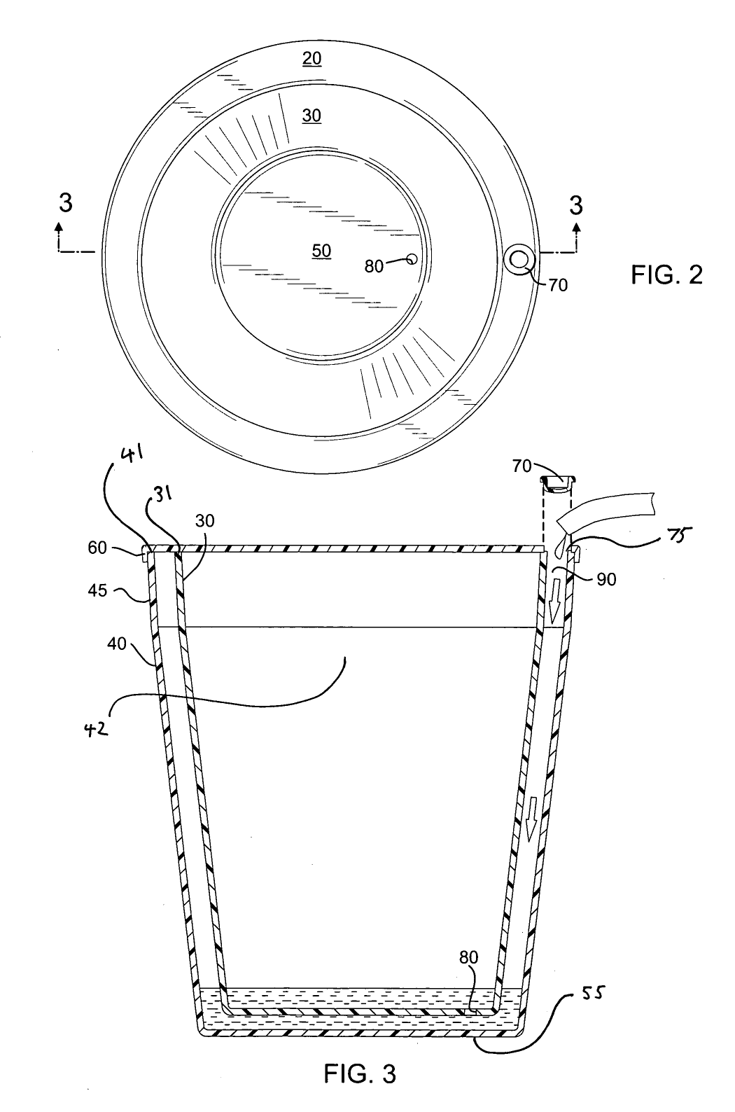

As seen in FIG. 2, the reservoir 90 is accessible by a reservoir intake opening 75 in the top surface 20. In an exemplary embodiment, the top surface 20 is secured to a collar portion 45 via a downwardly extending lip 60, which extends from the upper surface 20. In one exemplary embodiment, the collar portion 45 is oriented in a plane that is different from a planer in which the outer wall 40 lies within. The area confined by, or within the inner wall 30, the inner bottom surface, and the top surface 20 is called the plant area 42.

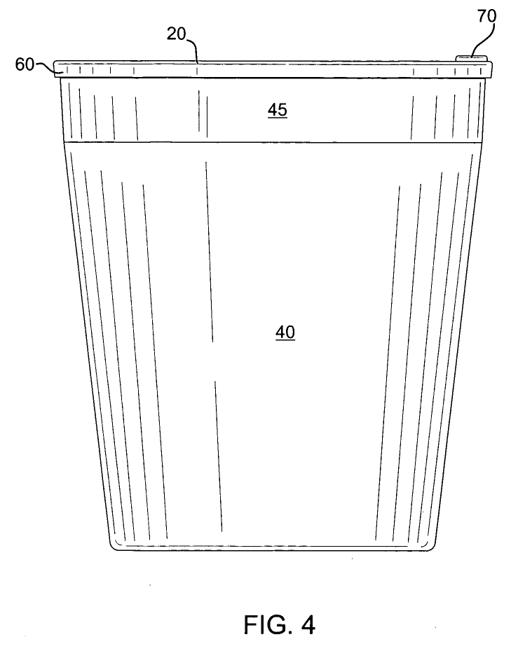

FIG. 4 illustrates the hydration system side view. A cap 70 can be used to close the reservoir intake opening 75, which seals the reservoir 90. This prevents debris from entering the reservoir 90. The cap 70 also prevents water from within the reservoir 90 from evaporating.

In operation, soil and a plant can be disposed within the plant area 42. Next the cap 70 can be removed, and water can be poured into the reservoir intake opening 75. Due to gravity, water will be moved downwardly in the reservoir 90. When the pressure pushing downwardly on the water within the reservoir 90 exceeds the pressure of the water at the soil aperture 80, water will be moved from the reservoir 90 to the plant area 42.

The inner bottom surface 50 has a soil aperture 80. The diameter of the soil aperture is about ⅛ of an inch. The reservoir 90 has a volume of about 475 mL.

Therefore the ratio of the soil volume area to the reservoir 90 is 1375:475, or 2.895 to 1. This ratio of “dirt volume” to “water volume” combined with a hole having a diameter about ⅛ of an inch in the bottom surface 100, has been found to be the optimum ratio, and rate of water entry, to maintain water for the plant roots, so the roots don't get too much water, or to little water. If the ratio varies from the above, the majority of the plants will get too much, or too little, which will disturb the plant's growth and health. This ratio is also optimum for reducing parasites or other pathogens. These plant pathogens can reside in the soil if too wet, or to dry. This ratio creates an optimum environment to discourage the pathogens.

Water is contained in the reservoir 90. The plant can then draw water through the liquid intake means, such as a sponge, this in turns moistens the dirt and sediment which the plant is resting in so the plant can absorb water and other nutrients. Generally one reservoir filling per month is adequate.

In one exemplary embodiment, the top surface 20 has an annular ring shape. The inner wall 30 can be concave-cylindrical in shape. The outer wall 40 can also be concave-cylindrical in shape.

In one exemplary embodiment, the collar portion 45 can have a surface that is oriented substantially vertically.

In one exemplary embodiment, this planter is made from a plastic that can be injection molded. In another embodiment, it is made from glass. Virtually any water proof material will work.

I claim:

1. A self-watering planter, comprising:
an inner bottom surface (50) having a soil aperture (80), said soil aperture having a diameter of about ⅛ of an inch;
an inner wall (30) extending upwardly from said inner bottom surface (50), said inner wall (30) terminating in an inner ridge (31);
a top surface (20) secured to said inner ridge (31), said top surface (20) extending radially outwardly in a substantially horizontal plane to an outer wall (40), said top surface (20) having a reservoir intake opening (75) that can be sealed by a cap (70);
said outer wall (40) having an outer top ridge (41) that is secured to said top surface 20, said outer wall disposed radially away from said inner wall (30), said outer wall (40) extending downwardly from said top ridge (41) to an outer bottom surface (55), said outer wall (40) and said outer bottom surface (55) disposed substantially concentric with said inner wall (30) and said inner bottom surface (50);
said top surface (20), said outer wall (40), said outer bottom wall (55), said inner wall (30), and said inner bottom wall (50) collectively define a reservoir (90) therebetween; and
said inner wall (30), said inner bottom wall (50) enclose an plant area (42);
whereby a ratio of said plant area to said reservoir is about 2.895 to 1.

2. A self-watering planter, wherein the improvement comprises:
an inner bottom surface (50) having a soil aperture (80);
an inner wall (30) extending upwardly from said inner bottom surface (50), said inner wall (30) terminating in an inner ridge (31);
a top surface (20) secured to said inner ridge (31), said top surface (20) extending radially outwardly in a substantially horizontal plane to an outer wall (40), said top surface (20) having a reservoir intake opening (75) that can be sealed by a cap (70);
said outer wall (40) having an outer top ridge (41) that is secured to said top surface 20, said outer wall disposed radially away from said inner wall (30), said outer wall (40) extending downwardly from said top ridge (41) to an outer bottom surface (55), said outer wall (40) and said outer bottom surface (55) disposed substantially concentric with said inner wall (30) and said inner bottom surface (50);
said top surface (20), said outer wall (40), said outer bottom wall (55), said inner wall (30), and said inner bottom wall (50) collectively define a reservoir (90) therebetween; and
said inner wall (30), said inner bottom wall (50) enclose an plant area (42);
whereby a ratio of said plant area to said reservoir is about 2.9 to 1.

3. A self-watering planter, wherein the improvement comprises:
an inner bottom surface (50) having a soil aperture (80);
an inner wall (30) extending upwardly from said inner bottom surface (50), said inner wall (30) terminating in an inner ridge (31);
a top surface (20) secured to said inner ridge (31), said top surface (20) extending radially outwardly in a substantially horizontal plane to an outer wall (40), said top surface (20) having a reservoir intake opening (75) that can be sealed by a cap (70);
said outer wall (40) having an outer top ridge (41) that is secured to said top surface 20, said outer wall disposed radially away from said inner wall (30), said outer wall (40) extending downwardly from said top ridge (41) to an outer bottom surface (55), said outer wall (40) and said outer bottom surface (55) disposed substantially concentric with said inner wall (30) and said inner bottom surface (50);
said top surface (20), said outer wall (40), said outer bottom wall (55), said inner wall (30), and said inner bottom wall (50) collectively define a reservoir (90) therebetween; and
said inner wall (30), said inner bottom wall (50) enclose an plant area (42);
whereby a ratio of said plant area to said reservoir is about 3 to 1.
